(19) United States
(12) Patent Application Publication
(10) Pub. No.: US 2008/0024705 A1
(43) Pub. Date: Jan. 31, 2008

(54) LIQUID CRYSTAL DISPLAY APPARATUS

(75) Inventors: Rei Hasegawa, Yokohama-shi (JP); Yuko Kizu, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/689,068

(22) Filed: Mar. 21, 2007

(30) Foreign Application Priority Data
Jul. 14, 2006 (JP) 2006-193779

(51) Int. Cl. G02F 1/1337

(52) U.S. Cl. 349/123

(57) ABSTRACT

According to one embodiment, a liquid crystal display apparatus includes a liquid crystal layer including: a first liquid crystal layer provided on a first alignment film of an array substrate; a second liquid crystal layer provided on a second alignment film of an opposing substrate; and a third liquid crystal layer provided between the first liquid crystal layer and the second liquid crystal layer, each of the first and second liquid crystal layers including the polymer material and the low molecular weight liquid crystal material, and the third liquid crystal layer including the low molecular weight liquid crystal material.

### CROSS-REFERENCE TO RELATED APPLICATIONS

This application is based upon and claims the benefit of priority from the prior Japanese Patent Applications No. 2006-193779, filed on Jul. 14, 2006; the entire contents of which are incorporated herein by reference.

### BACKGROUND OF THE INVENTION

1. Field

One embodiment of the invention relates to a liquid crystal display apparatus. More particularly, it relates to an active matrix type liquid crystal display apparatus in which the liquid crystal material exhibits a bend alignment.

2. Background Art

A π cell and OCB (optically compensated bend) mode is a liquid crystal display mode capable of implementing a wide viewing angle and a high speed response. With a liquid crystal display apparatus adopting such a display mode, during the period in which an image is displayed, the tilt angle of the liquid crystal molecules in the vicinity of the back-side electrode and the front-side electrode is changed while holding the bend alignment. Then, utilizing the changes in retardation of the liquid crystal layer with the changes in tilt angle, images are displayed.

Conventionally, for the start of a π cell and OCB mode liquid crystal display apparatus, it has been necessary to apply a voltage of several volts or more across the back-side electrode and the front-side electrode for several seconds to several minutes, and to cause a transition from the splay alignment to the bend alignment. Such an initial transition inhibits the application of the π cell and OCB mode.

In T. Konno et al., OCB-Cell Using Polymer Stabilized Bend Alignment, ASIA DISPLAY '95, pp. 581 to 583, there is described a technology eliminating the necessity of the initial transition. Specifically, a mixture of an ultraviolet curable monomer and a nematic liquid crystal material is applied with an initializing voltage. Thus, a transition from a splay alignment to a bend alignment is caused. Then, the foregoing mixture is irradiated with an ultraviolet ray in this state, thereby to form a polymer network.

In the liquid crystal cell obtained in this manner, the liquid crystal material exhibits a twist alignment with no voltage applied thereto. At a given voltage or higher, the optical characteristics of the twist alignment and the bend alignment are roughly the same. Further, the transition from the twist alignment to the bend alignment is very fast. Therefore, the liquid crystal cell does not require initial transition.

Whereas, in order to obtain the guest-host effect, the following technology is disclosed. By the use of a mixed solution of a reaction curable polymer material containing liquid crystalline monomers and a liquid crystal material including a nematic liquid crystal, an electric field is applied across the electrodes, and an ultraviolet ray is applied thereto via a photomask. This results in a structure in which the liquid crystalline polymers are arranged in standing postures in the direction of thickness of the liquid crystal layer (JP-A-2004-219948 (the term “JP-A” as used herein means an “unexamined published Japanese patent application”)).

However, in the case where the technologies described above are applied to, for example, an active matrix driving system liquid crystal display apparatus, unfavorably, for example, uneven display tends to occur when an external force is applied on the liquid crystal display apparatus. Whereas, unfavorably, the response speed of the liquid crystal is reduced by the effects of the polymer network.

### SUMMARY OF THE INVENTION

Under such circumstances, it is an object of the present invention to provide a liquid crystal display apparatus which eliminates the necessity of the initial transition for causing the liquid crystal material to exhibit a bend alignment, and is less likely to present uneven display when an external force is applied thereto.

According to an aspect of the invention, a liquid crystal display apparatus includes: an array substrate including: a plurality of scanning lines; a plurality of signal lines crossing with the plurality of scanning lines; pixel switches arrayed correspondingly to intersections of the plurality of scanning lines and signal lines, and controlled in the switching operation by scanning signals supplied from the scanning lines; pixel electrodes connected to the signal lines via the pixel switches; and a first alignment film covering the pixel electrodes; and an opposing substrate including: an opposing electrode facing the pixel electrodes; and a second alignment film covering the pixel electrode side of the opposing electrode, and placed at a position facing the first alignment film; and a liquid crystal layer sealed between the first alignment film and the second alignment film, exhibiting a bend alignment with no voltage applied thereto, and containing a polymer material and a low molecular weight liquid crystal material lower in molecular weight than the polymer material, wherein the liquid crystal layer includes: a first liquid crystal layer provided on the first alignment film of the array substrate; a second liquid crystal layer provided on the second alignment film of the opposing substrate; and a third liquid crystal layer provided between the first liquid crystal layer and the second liquid crystal layer, each of the first and second liquid crystal layers includes the polymer material and the low molecular weight liquid crystal material, and the third liquid crystal layer includes the low molecular weight liquid crystal material.

There is provided a liquid crystal display apparatus which eliminates the necessity of the initial transition for causing the liquid crystal material to exhibit a bend alignment, and is less likely to present uneven display when an external force is applied thereto.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a plan view schematically showing a liquid crystal display apparatus in accordance with one embodiment of the present invention;

FIG. 2 is a fragmentary cross sectional view schematically showing a structure adoptable for the liquid crystal display apparatus of FIG. 1;

FIG. 3 is a fragmentary cross sectional view specifically showing a liquid crystal layer 30 shown in FIG. 2;

FIG. 4 is a fragmentary cross sectional view schematically showing a liquid crystal display apparatus in accordance with another modified example; and

FIG. 5 is a fragmentary cross sectional view schematically showing a liquid crystal display apparatus in accordance with an example.

### DETAILED DESCRIPTION OF THE INVENTION

Below, embodiments of the present invention will be described by reference to the accompanying drawings. Incidentally, in the respective drawings, the elements exerting the same or similar functions are given the same reference numerals and signs. An overlapping description will be omitted. Further, the drawings are schematic, and the relationships between thicknesses and planar dimensions, the ratios of thickness between respective layers, and the like differ from the actual ones. Further, the dimensional relationships and ratios also differ from one another among some drawings.

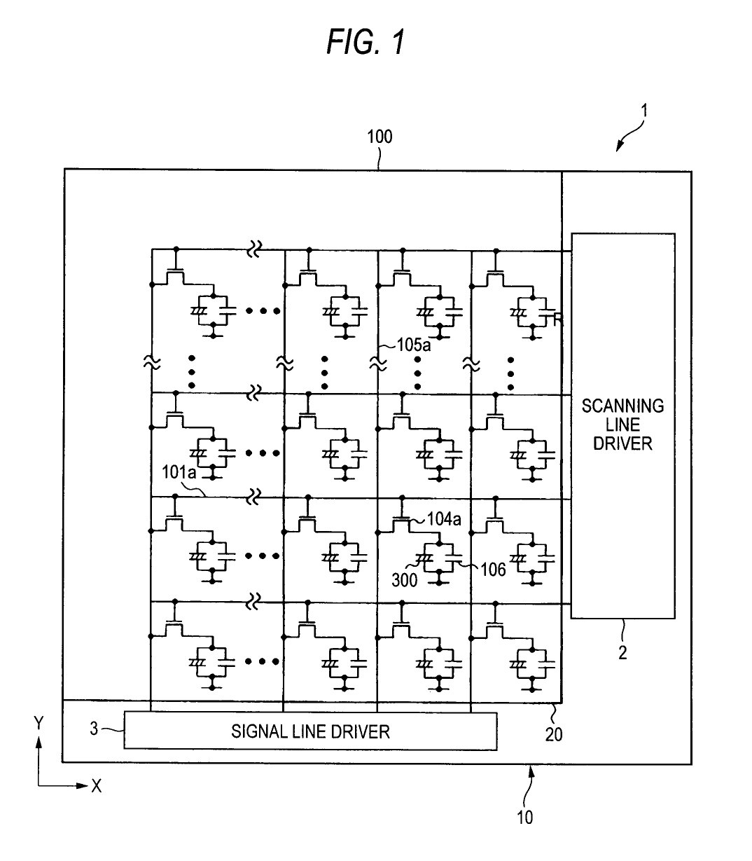

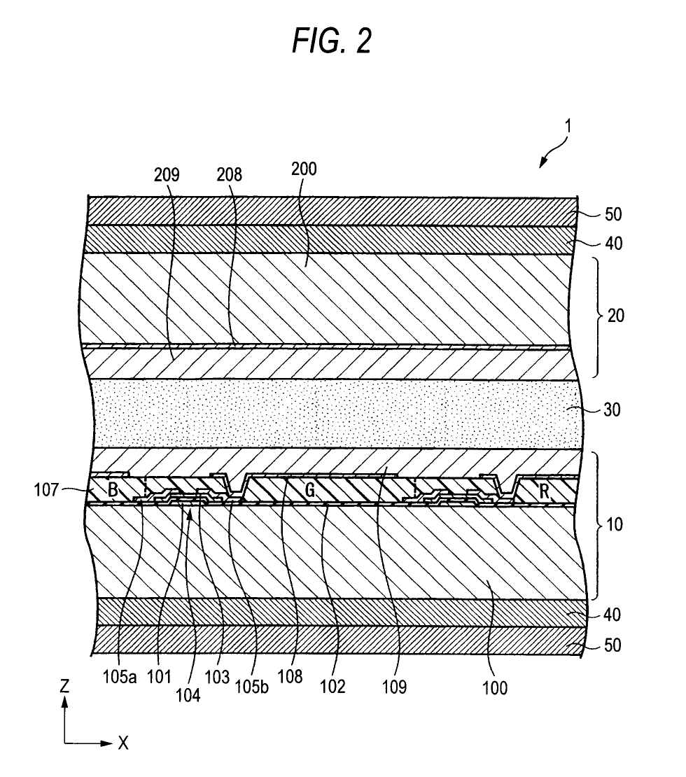

FIG. 1 is a plan view schematically showing a liquid crystal display apparatus in accordance with one embodiment of the invention. FIG. 2 is a fragmentary cross sectional view schematically showing one example of a configuration adoptable for the liquid crystal display apparatus of FIG. 1.

The liquid crystal display apparatus of FIG. 1 and FIG. 2 is an OCB mode active matrix type liquid crystal display apparatus. The liquid crystal display apparatus includes a liquid crystal display panel 1, a backlight disposed so as to be opposed thereto (not shown), and a scanning line driver 2 and a signal line driver 3 connected to the liquid crystal display panel 1.

The liquid crystal display panel 1 includes an array substrate 10 and an opposing substrate 20. Between the array substrate 10 and the opposing substrate 20, a seal layer in the form of a frame (not shown) is present. The space surrounded by the array substrate 10, the opposing substrate 20, and the seal layer is filled with a mixture containing a polymer material and a low molecular weight liquid crystal material lower in molecular weight than this. The mixture forms a liquid crystal layer 30. Further, on the outside of the array substrate 10, an optical compensation film 40 and a polarizing plate 50 are successively disposed. On the outside of the opposing substrate 20, an optical compensation film 40 and a polarizing plate 50 are successively disposed.

The array substrate 10 includes a transparent substrate 100 such as a glass substrate or a plastic substrate.

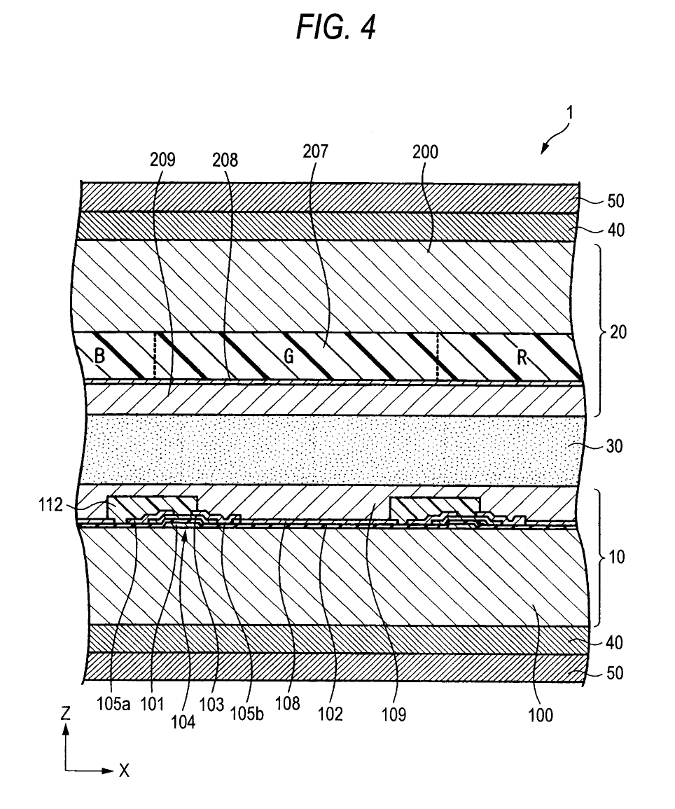

On the transparent substrate 100, a scanning line 101 and an storage capacitance line not shown are disposed. The scanning lines 101 and the storage capacitance lines each extend in the direction X, and are alternately arranged in the direction Y (in the direction of paper plane in FIG. 2 and FIG. 4, the same applies to the following.) crossing with the direction X.

The scanning lines 101 and the storage capacitance lines can be formed by the same step. Whereas, as these materials, for example, metals or alloys can be used. A part of the scanning line 101 is, in a region of a thin film transistor (TFT: thin film transistor), used as a gate electrode of the thin film transistor.

The scanning lines 101 and the storage capacitance lines are covered with an insulating film 102. As the insulating film 102, for example, a silicon oxide film can be used.

On the insulating film 102, semiconductor layers 103 are arrayed correspondingly to the gate electrodes. These semiconductor layers 103 respectively cross with the gate electrodes. The semiconductor layers 103 are formed of, for example, amorphous silicon. Further, on each semiconductor layer 103, a channel protective layer and an ohmic layer not shown are formed.

A thin film transistor is formed of the gate electrode, the semiconductor layer 103, and a portion of the insulating film 102 situated between the gate electrode and the semiconductor layer 103 (gate insulating film). The thin film transistor is utilized as a pixel switch 104.

Incidentally, in this example, the pixel switch 104 is an n channel thin film transistor. More specifically, it is an amorphous silicon n channel thin film transistor. However, the pixel switch 104 is not limited thereto. A polysilicon thin film transistor may be used. Alternatively, in place of using such a thin film transistor, another switching element such as a thin film diode may be used.

On the insulating film 102, signal lines 105a and source electrodes 105b are further disposed. The signal lines 105a respectively extend in the direction Y, and are arrayed in the direction X correspondingly to the rows formed by the pixel switches 104. The signal line 105a covers a drain of the semiconductor layer 103 included in the pixel switch 104. Namely, a part of each signal line 105a is a drain electrode connected to the pixel switch 104.

The source electrodes 105b are arrayed correspondingly to the pixel switches 104. Each source electrode 105b functions as the source electrode of the switch 104, and faces the storage capacitance line. The source electrode 105b, the storage capacitance line, and the insulating film 102 present therebetween form a capacitor 106.

On the insulating film 102, a color filter 107 is further disposed. The color filter 107 includes colored layers of, for example, blue (B), green (G), and red (R).

On the color filter 107, pixel electrodes 108 are arrayed. The pixel electrodes 108 are respectively connected to the source electrodes 105b through via holes formed in the color filter 107. As the material for the pixel electrodes 108, for example, ITO (indium tin oxide) can be used.

The pixel electrodes 108 are covered with an alignment film 109. The alignment film 109 allows liquid crystal molecules to be oriented in a tilted manner at a relatively large pretilt angle of, for example, 5° to 10° in the vicinity thereof. The alignment film 109 can be obtained by subjecting an organic film formed of, for example, acrylic, polyimide, nylon, polyamide, polycarbonate, benzocyclobutene polymer, polyacrylonitrile, or polysilane to an alignment treatment such as rubbing. Alternatively, the alignment film 109 can be obtained by obliquely depositing, for example, silicon oxide. Out of these, in terms of the ease of deposition and the chemical stability, polyimide, polyacrylonitrile, and nylon are excellent. In this example, as the alignment film 109, a polyimide film which has been rubbed along the direction Y is assumed to be used.

On the insulating film 102, a scanning signal input terminal group (not shown) and an image signal input terminal group (not shown) are further placed. The scanning signal input terminals and the image signal input terminals are connected to the scanning lines 101 and the signal lines 105a, respectively. As the materials for these terminals, for example, metals or alloys can be used.

The opposing substrate 20 includes a transparent substrate 200 such as a glass substrate or a plastic substrate.

On the opposing substrate 20, an opposing electrode 208 is formed. The opposing electrode 208 is a common electrode facing the pixel electrodes 108. As the material for the opposing electrode 208, for example, ITO can be used.

The opposing electrode 208 is covered with an alignment film 209. As the alignment film 209, the same film as the alignment film 109 can be used. In this example, as the alignment film 209, a polyimide film which has been rubbed in the same direction as with the alignment film 109 is assumed to be used.

The array substrate 10 and the opposing substrate 20 are configured such that their respective alignment films 109 and 209 face each other. Between the array substrate 10 and the opposing substrate 20, a seal layer in the form of a frame (not shown) is present. The scanning signal input terminals and the image signal input terminals are situated on the outside of the frame formed by the seal layer. The seal layer establishes mutual bonding between the array substrate 10 and the opposing substrate 20. As the material for the seal layer, an epoxy type or acrylic type adhesive can be used.

A transfer electrode not shown is placed between the array substrate 10 and the opposing substrate 20, and on the outside of the frame formed by the seal layer. The transfer electrode connects the opposing electrode 208 to the array substrate 10.

A granular spacer is present between the array substrate 10 and the opposing substrate 20. Alternatively, at least one of the array substrate 10 and the opposing substrate 20 further includes a columnar spacer not shown. The spacer forms a space with a roughly constant thickness between the array substrate 10 and the opposing substrate 20, and at the positions outside of the pixel electrodes 108.

The space surrounded by the array substrate 10, the opposing substrate 20, and the seal layer in the form of a frame is filled with a mixture containing a polymer material and a low molecular weight liquid crystal material lower in molecular weight than this. The mixture forms the liquid crystal layer 30.

The polymer material has an average molecular weight of 5000 or more. Incidentally, the term “average molecular weight” herein referred to is the number average molecular weight determined by gel permeation chromatography. The polymer material forms a polymer matrix or a polymer network in the liquid crystal layer 30.

The low molecular weight material has a molecular weight of 1000 or less. The low molecular weight liquid crystal material is, for example, a nematic liquid crystal material with a positive dielectric constant anisotropy.

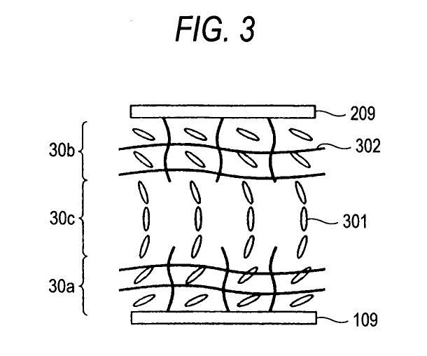

FIG. 3 is a fragmentary cross-sectional view more specifically showing the liquid crystal layer 30 shown in FIG. 2.

The liquid crystal layer 30 includes, as shown in FIG. 3, a first liquid crystal layer 30a disposed in the adjacent region on the alignment film 109 of the array substrate 10, a second liquid crystal layer 30b disposed in the adjacent region on the alignment film 209 of the opposing substrate 20, and a third liquid crystal layer 30c interposed between the first liquid crystal layer 30a and the second liquid crystal layer 30b. A detailed configuration of the liquid crystal layer 30 will be described later.

The pixel electrodes 108, the opposing electrode 208, the alignment films 109 and 209, and the liquid crystal layer 30 form a liquid crystal element 300. Each pixel includes the pixel switch 104, the liquid crystal element 300, and the capacitor 106. Whereas, the array substrate 10, the opposing substrate 20, and the liquid crystal layer 30 and the seal layer present therebetween form a liquid crystal cell.

The optical compensation film 40 is, for example, a biaxial film. As the optical compensation film 40, there can be used the one including an optically anisotropic layer in which a uniaxial compound with a negative refractive index anisotropy such as a discotic liquid crystal compound provides a hybrid alignment so that the optical axis changes within a plane perpendicular to the direction X.

The total retardation of the optical compensation films 40 bonded to the array substrate 10 and the opposing substrate 20 is set to be roughly equal to, for example, the retardation of the liquid crystal layer 30 in an ON state. In this case, the optical compensation films 40 are disposed, for example, such that the retardation of a lamination of the liquid crystal layer 30 in an ON state and the optical compensation films 40 is roughly zero.

The polarizing plates 50 are disposed, for example, such that their transmission axes are generally orthogonal to each other. Further, each polarizing plate 50 is disposed, for example, such that the transmission axis forms an angle of about 45° with respect to the direction X and the direction Y.

The scanning line driver 2 and the signal line driver 3 are connected to the scanning signal input terminal and the image signal input terminal, respectively. In this example, the drivers 2 and 3 are COG (chip on glass) mounted. However, they may be TCP (tape carrier package) mounted instead.

A backlight not shown is disposed on the back side of the liquid crystal display panel 1. The backlight illuminates the array substrate 10 from the back side.

The liquid crystal layer 30 described above is manufactured in the following manner.

First, the array substrate 10 shown in FIG. 2 is manufactured by a known method, and a columnar spacer is formed on the alignment film 109 of the array substrate 10. Further, the opposing substrate 20 shown in FIG. 2 is manufactured by a known method. Then, under vacuum, on the alignment film 109 of the array substrate 10, a mixture containing a polymer material precursor and a low molecular weight liquid crystal material is fell into drops. Thereafter, the array substrate 10 and the opposing substrate 20 are disposed such that the alignment film 109 and the alignment film 209 face each other. At this step, the distance between the array substrate 10 and the opposing substrate 20 is uniformly controlled by the columnar spacer formed on the array substrate 10. Incidentally, to the mixture, a photopolymerization initiator may be further added.

In this state, all the scanning lines 101 are applied with a voltage such that the pixel switches 104 are rendered in an ON state through the scanning signal input terminal and the image signal input terminal. In addition, all the signal lines 105a are applied with a given voltage (e.g., 0 volt). Simultaneously, the opposing electrode 208 is applied with an alternating current voltage of several volts or more. As a result, the low molecular weight liquid crystal material interposed between the pixel electrodes 108 and the opposing electrode 208 exhibits a bend alignment. Thereafter, in this state, the polymerization reaction of the polymer material precursor in the mixture is effected. The polymerization reaction is carried out by, for example, irradiating the mixture with an ultraviolet ray from the array substrate 10 side and the opposing substrate 20 side. The irradiation time of an ultraviolet ray is, for example, 3 seconds or more, although it depends upon the intensity of the ultraviolet ray for irradiation. Incidentally, when the irradiation time is short, in some cases, the polymerization reaction of the polymer material precursor does not sufficiently proceed, and the bend alignment cannot be stabilized.

Thereafter, the array substrate 10 and the opposing substrate 20 are peeled off by gradually exerting a force from the corner portions of the respective substrates 100 and 200. This results in the formation of the first liquid crystal layer 30a made of a polymer material and low molecular weight liquid crystal layer on the alignment film 109, and the second liquid crystal layer 30b made of a polymer material and low molecular weight liquid crystal layer having the same configuration as that of the first liquid crystal layer 30a on the alignment film 209.

Then, on the first liquid crystal layer 30a, spacer particles having a larger diameter than the height of the columnar spacer are dispersed. Further, in the periphery part of the opposing substrate 20 having the alignment film 209 formed therein, a sealing agent is coated in the form of a frame so as to surround the second liquid crystal layer 30b except for the portion serving as an injection port. These are bonded together so that the alignment film 109 and the alignment film 209 face each other. The sealing agent is cured under a load. As a result, a cell having a cavity between the first liquid crystal layer 30a and the second liquid crystal layer 30b is manufactured.

Then, the inside of the cell is evacuated, and a low molecular weight liquid crystal material is injected therein. Thus, the injection port of the cell is closed, thereby to manufacture a liquid crystal cell. This results in the formation of the liquid crystal layer 30 in which the first liquid crystal layer 30a, the third liquid crystal layer 30c, and the second liquid crystal layer 30b are successively stacked on the alignment film 109.

Subsequently, onto the manufactured liquid crystal cell, the optical compensation films 40 and the polarizing plates 50 are bonded. Further, the scanning line driver 2 and the signal line driver 3 are mounted thereon to manufacture the liquid crystal display panel 1. Then, the resulting liquid crystal display panel 1 is combined with a backlight and the like to complete a liquid crystal display apparatus.

In the manufacturing method, as the polymer material precursor used, for example, a liquid crystalline acrylate monomer such as a monofunctional acrylate monomer exhibiting liquid crystallinity (an acrylate monomer containing one acrylic double bond in the molecule) can be used. Examples of such an acrylate monomer usable may include the compounds represented by the following chemical formulae (1) to (3):

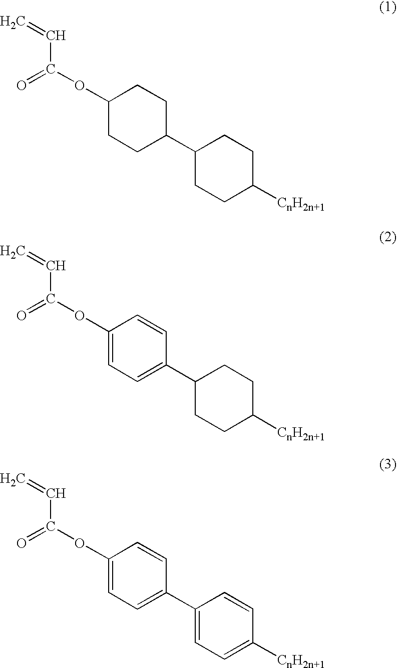

Examples of the polymer material included in the liquid crystal layer 30 include a side chain type polymer liquid crystal material in which a rigid mesogen group is directly or indirectly bonded to the polymer skeleton as a side chain. Example of the side chain type polymer liquid crystal material usable may include the polymers represented by the following chemical formulae (4) to (6):

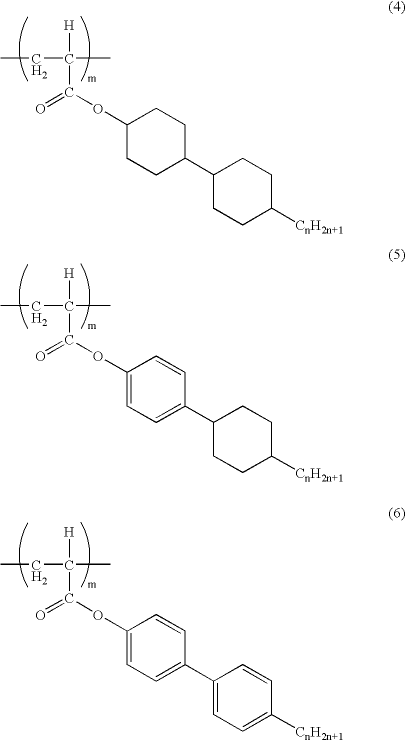

The weight percentage of the polymer material in the first liquid crystal layer 30a and the second liquid crystal layer 30b is configured to fall within a range of, for example, from 2.5% to 10% where the weight of the mixture of the polymer material and the low molecular weight liquid crystal is 100%. When the weight percentage of the polymer material exceeds, for example, 10%, light may scatter, or the electric field response of the liquid crystal may be inhibited under the influence of the polymer material, resulting in a reduction of contrast ratio. When the weight percentage of the polymer material is less than, for example, 2.5%, with no voltage applied thereto, the liquid crystal material becomes more likely to exhibit a splay alignment, namely, a bend alignment becomes less likely to occur.

The liquid crystal layer 30 has a lamination structure of the first liquid crystal layer 30a, the third liquid crystal layer 30c, and the second liquid crystal layer 30b from the array substrate 10 side. Incidentally, the third liquid crystal layer 30c scarcely contains the polymer material. Typically, the polymer material of the third liquid crystal layer 30c is preferably configured in an amount within a range of 0.5% or less based on the weight percentage of the third liquid crystal layer 30c. This will be described by reference to FIG. 3 described above.

FIG. 3 is a cross sectional view schematically showing the orientation state of the liquid crystal material when no voltage is applied thereto. In the diagram, a reference numeral 301 denotes a low molecular weight liquid crystal material, and a reference numeral 302 denotes a side chain type polymer liquid crystal material (polymer material).

In the first liquid crystal layer 30a and the second liquid crystal layer 30b, the low molecular weight liquid crystal material 301 contains the polymer material 302 therein. Therefore, the low molecular weight liquid crystal material 301 exhibits a bend alignment even with no voltage applied between the pixel electrodes 108 and the opposing electrode 208. This can eliminate the necessity of the initial transition in the liquid crystal display apparatus.

Incidentally, in the case where an external force is applied on a liquid crystal display apparatus having a structure in which the liquid crystalline polymers are arranged in standing postures in the direction of thickness of the liquid crystal layer 30, for example, when the polarizing plate 50 bonded onto the opposing substrate 20 is pressed with fingers, the space between the array substrate 10 and the opposing substrate 20 narrows with the portion pressed with fingers as the center, so that the orientation of the liquid crystal becomes disordered. Generally, spacer particles or columnar spacers are disposed between the array substrate 10 and the opposing substrate 20. However, they are elastically deformed by an external force, so that the space between the array substrate 10 and the opposing substrate 20 is temporarily reduced to, for example, about half of the initial value. When the external force is removed, the space between the substrates 10 and 20 is recovered. At this step, when the liquid crystal layer is configured of only the low molecular weight liquid crystal material, the liquid crystal orientation recovers to the original uniform state because the low molecular weight liquid crystal material has flowability

On the other hand, when the whole liquid crystal layer 30 contains a polymer material, and the low molecular weight liquid crystal material holds the bend alignment by the polymer material, the structure of the polymer matrix may be deformed when the space between the substrates 10 and 20 is narrowed by an external force. In this case, even when the external force is removed, and the space between the substrates 10 and 20 is recovered, the liquid crystal orientation does not recover or recovers slowly under the influence of the deformed polymer matrix. As a result, the portion applied with the external force is visually identified as uneven display, resulting in defective display.

Incidentally, as shown in FIG. 3, in the invention, the liquid crystal layer 30 has a lamination structure of, from the array substrate 10 side, the first liquid crystal layer 30a, the third liquid crystal layer 30c, and the second liquid crystal layer 30b. In the third liquid crystal layer 30c interposed between the first liquid crystal layer 30a and the second liquid crystal layer 30b, the polymer material is scarcely contained. For this reason, even when the space between the substrates 10 and 20 is narrowed by an external force, the polymer material 302 contained in the first liquid crystal layer 30a and the polymer material 302 contained in the second liquid crystal layer 30b become less likely to hit each other. Therefore, the deformation of the structure of the polymer matrix becomes less likely to occur. As a result, even when the liquid crystal display apparatus is applied with an external force, it is possible to reduce the tendency of uneven display to occur.

Whereas, in the case where a polymer material is contained in the central portion in the direction of a cross section of the liquid crystal cell, i.e., the portion of the third liquid crystal layer 30c, in some cases, when the liquid crystal molecules are switched by changing the voltage to be applied to the liquid crystal layer 30, the flow of the liquid crystal is inhibited by the polymer material, resulting in a reduction of the switching speed. However, in the invention, the third liquid crystal layer 30c scarcely contains the polymer material, and hence the reduction of the switching speed does not occur.

FIG. 3 shows, as one example, a straight-chain-like polymer skeleton extending generally in parallel with the direction Y. However, the polymer skeleton may extend in any direction. Whereas, the polymer skeleton may assume any conformation. Further, the polymer skeleton may be branched. For example, the polymer skeleton may have a two dimensional network structure, or may have a three dimensional network structure.

Incidentally, the liquid crystal layer 30 is applicable to other forms than the liquid crystal display apparatus shown in FIGS. 1 and 2.

FIG. 4 is a plan view schematically showing a liquid crystal display apparatus in accordance with another modified example. The liquid crystal display apparatus has almost the same structure as that of the liquid crystal display apparatus shown in FIGS. 1 and 2, except for adopting the following configuration for the array substrate 10 and the opposing substrate 20. Therefore, a description will be omitted for the overlapping portions.

Namely, in the liquid crystal display apparatus of FIG. 4, the color filter 107 is omitted from the array substrate 10. Instead, between the substrate 200 and the opposing electrode 208 of the opposing substrate 20, a color filter 207 is disposed. Further, in the liquid crystal display apparatus of FIG. 4, between the signal lines 105a and the alignment film 109, a black matrix 112 is disposed. Thus, a color filter/on/array structure may be adopted, and a black matrix/on/array structure may be adopted.

Incidentally, in the liquid crystal display apparatus of FIG. 4, between the color filter 207 and the opposing electrode 208, a planarization layer may be disposed. When the planarization layer is disposed, the smoothness of the opposing electrode 208 is enhanced. Accordingly, the degree of orientation of the liquid crystal material is improved, and an undesirable short circuit between the members included in the array substrate 10 and the opposing electrode 208 becomes less likely to occur.

Examples of the material usable for the planarization layer include organic substances such as acrylic, polyimide, nylon, polyamide, polycarbonate, benzocyclobutene polymer, polyacrylonitrile, and polysilane. Out of these materials, acrylic or the like is excellent in terms of the cost. Benzocyclobutene polymer or the like is excellent in terms of the smoothness. Polyimide or the like is excellent in terms of the chemical stability.

### EXAMPLES

Below, Examples of the invention will be described.

### Example 1

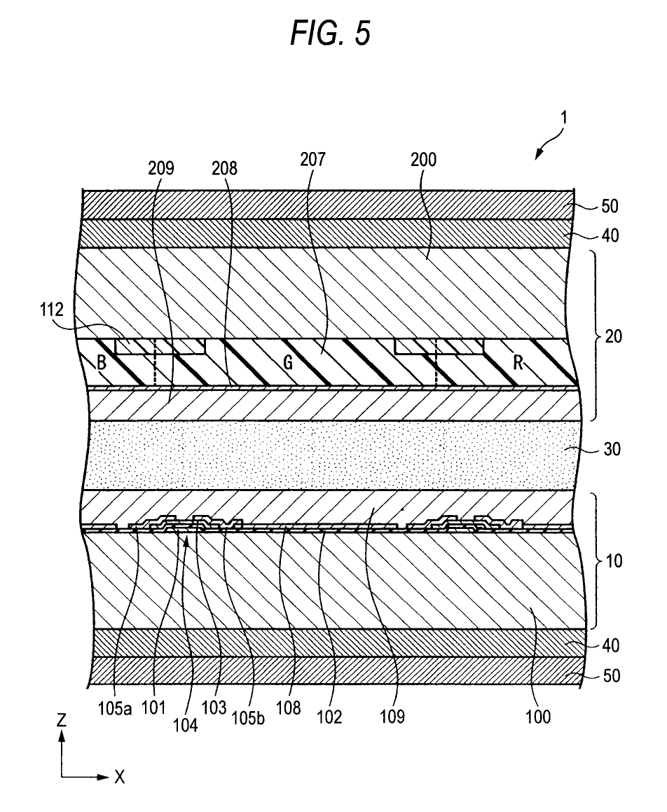

In this example, the liquid crystal display apparatus shown in FIG. 1 was manufactured in the following manner. Incidentally, in this example, the structure shown in FIG. 5 was adopted for the array substrate 10 and the opposing substrate 20. The liquid crystal display apparatus shown in FIG. 5 is equal in configuration to that of FIG. 4, except that the black matrix 112 provided between the signal lines 105a and the alignment film 109 shown in FIG. 4 is disposed between the substrate 200 and the color filter 207 of the opposing substrate 20.

For manufacturing the array substrate 10, first, the scanning lines 101 and storage capacitance lines (not shown) were formed on a glass substrate 100. As the material for the lines, chromium was used.

Then, the storage capacitance lines and the scanning lines 101 were covered with the insulating film 102 having a lamination structure of a chromium oxide film and a silicon oxide film. On the insulating film 102, the semiconductor layer 103 made of amorphous silicon was formed. The semiconductor layer 103 was then patterned. Thereafter, on the semiconductor layer 103, a channel protective layer (not shown) made of silicon nitride was formed. Thus, on the semiconductor layer 103 and the channel protective layer, an ohmic layer not shown was formed.

Then, on the insulating film 102, the signal lines 105a, the source electrodes 105b, the scanning signal input terminal (not shown), and the image signal input terminal (not shown) were formed. Further, on the insulating film 102, the pixel electrodes 108 were formed.

For manufacturing the opposing substrate 20, first, on the glass substrate 200, chromium was coated, and this was patterned. This resulted in a black matrix. Subsequently, the striped color filter 207 was formed thereon by the use of photosensitive acrylic resins respectively containing red, green, and blue pigments mixed therein.

Then, on the color filter 207, a transparent acrylic resin was coated to form a planarization layer (overcoat) not shown. Thereafter, on the planarization layer, ITO was sputtered, thereby to form the opposing electrode 208. Further, on the opposing electrode 208, columnar spacers (not shown) each having a height of 3 μm, and a bottom of 5 μm×10 μm were formed by using a photolithography process. The columnar spacers were formed so as to be situated on the signal lines 105a when the array substrate 10 and the opposing substrate 20 were bonded together.

After washing the pixel electrodes 108 and the opposing electrode 208, a polyimide solution (SE-5291, manufactured by NISSAN CHEMICAL INDUSTRIES, Ltd.) was coated thereon by offset printing. By the use of a hot plate, these coating films were heated at 90° C. for 1 minute, and further heated at 200° C. for 30 minutes. Thus, the alignment films 109 and 209 were formed.

Then, the alignment films 109 and 209 were subjected to rubbing using a cloth made of cotton. These rubbing treatments were carried out such that the direction of rubbing on the alignment film 109 and the direction of rubbing on the alignment film 209 became the same direction when the array substrate 10 and the opposing substrate 20 were bonded together. Whereas, for the rubbing treatments, a rubbing cloth made of cotton, having a fiber tip diameter of 0.1 μm to 10 μm was used. The number of revolutions of the rubbing roller was set at 500 rpm; the substrate transport speed, 20 mm/s; the overlap length, 0.7 mm; and the number of rubbing treatments, one. Further, after rubbing, the alignment films 109 and 209 were washed with an aqueous solution containing a neutral surfactant as a main component.

Then, under vacuum, on the alignment film 109, a mixture containing a polymer material precursor and a low molecular weight liquid crystal material was fell into drops. As the low molecular weight liquid crystal material, E7 manufactured by Merck Japan Ltd., which is a nematic liquid crystal composition was used. The concentration in the mixture was set at 95% in terms of weight percentage. As the polymer material precursor, UCL-001 (manufactured by Dainippon Ink and Chemicals, Incorporated), which is an acrylate monomer showing liquid crystallinity was used. The concentration in the mixture was set at 4.95% (wt %). Further, as a photopolymerization initiator, 2,2-dimethoxy-2-phenylacetophenone was used. The concentration in the mixture was set at 0.05% (wt %).

Subsequently, the array substrate 10 and the opposing substrate 20 were disposed such that the alignment films 109 and 209 faced each other, and such that their respective rubbing directions were equal to each other. At this step, the array substrate 10 and the opposing substrate 20 were uniformly controlled at a distance of about 3 μm from each other by the columnar spacers formed on the array substrate 10.

In this state, through the scanning signal input terminals and the image signal input terminals, all the scanning lines 101 were applied with a direct current voltage of 25 V. Thus, all the pixel switches 104 were rendered in an ON state. In addition, all the signal lines 105a were applied with 0 V. Simultaneously, the opposing electrode 208 was applied with an alternating current voltage of ±5 V. As a result, the low molecular weight liquid crystal material interposed between the pixel electrodes 108 and the opposing electrode 208 exhibited a bend alignment. In this state, from the opposite side of the array substrate 10 from the side having the alignment film 109 formed thereon, an ultraviolet ray having a main wavelength of 365 nm and an intensity of 3.3 mW/cm² was applied for 3 minutes. As a result, the polymer material precursors were polymerized, so that a liquid crystal layer containing the polymer material and the low molecular weight liquid crystal material was formed.

Thereafter, the array substrate 10 and the opposing substrate 20 were peeled off by gradually exerting a force from the corner portions of the respective substrates 10 and 20. As a result, the liquid crystal layer was divided into two portions. Thus, on the alignment film 109, the first liquid crystal layer 30a made of the polymer material and low molecular weight liquid crystal layer was formed. Whereas, on the alignment film 209, the second liquid crystal layer 30b made of the polymer material and low molecular weight liquid crystal layer was formed.

On the alignment film 109, spacer particles having a diameter of 5 μm were dispersed. Further, in the periphery part of the opposing substrate 20 having the alignment film 209 formed therein, an epoxy type sealing agent was coated in the form of a frame so as to surround the second liquid crystal layer 30b except for the portion serving as an injection port. These were bonded together such that the alignment film 109 and the alignment film 209 faced each other, and such that their respective rubbing directions were equal to each other. The sealing agent was cured under a load. As a result, a cell having a cavity between the first liquid crystal layer 30a and the second liquid crystal layer 30b was manufactured.

Then, the obtained cell was transported into a vacuum chamber. The inside of the cell was evacuated, and a low molecular weight liquid crystal material (E7 manufactured by Merck Japan Ltd.) was injected through the injection port. Further, the injection port of the cell was sealed with an epoxy type adhesive. This resulted in the formation of the liquid crystal layer 30 in which the first liquid crystal layer 30a, the third liquid crystal layer 30c, and the second liquid crystal layer 30b were successively stacked on the alignment film 109, and the low molecular weight liquid crystal material contained therein exhibited a bend alignment with no voltage applied thereto. Further, the third liquid crystal layer 30c scarcely contained the polymer material and the polymer material precursor.

Then, on the outside of the array substrate 10, the optical compensation film 40 and the polarizing plate 50 were bonded. In addition, on the outside of the opposing substrate 20, the optical compensation film 40 and the polarizing plate 50 were bonded. Herein, there was adopted a design such that the retardation of a lamination of the liquid crystal layer 30 between the pixel electrodes 108 and the opposing electrode 208 with a voltage of 5 V applied between the pixel electrodes 108 and the opposing electrode 208, and a total of two optical compensation films 40 bonded on the array substrate and the opposing substrate becomes zero within the substrate plane. Whereas, the polarizing plates 50 were placed such that their transmission axes were generally orthogonal to each other, and such that their respective transmission axes formed an angle of about 45° with respect to the direction X and the direction Y.

Further, to the array substrate 10, the scanning line driver 2, the signal line driver 3, and the like were connected. Thus, the liquid crystal display panel 1 and a backlight were combined. In the foregoing manner, the liquid crystal display apparatus was completed.

With the liquid crystal display apparatus, even when the liquid crystal panel was strongly pressed with fingers, uneven display did not occur. Incidentally, the absolute value of the voltage to be applied between the pixel electrodes 108 and the opposing electrode 208 was set at 5 V for the ON state, and it was set at 0 V for the OFF state. The front contrast ratio was 400:1, and the response time was 5 ms. The viewing angles (satisfying the conditions such that the contrast ratio is 10:1 or more, and such that gradation inversion is not caused) were 70° or more both in the vertical direction and in the horizontal direction.

### Example 2

The steps up to the point when the alignment films 109 and 209 were formed on the array substrate 10 and the opposing substrate 20, respectively, and a rubbing treatment was carried out, and then, the alignment films 109 and 209 were washed were carried out in the same manner as in Example 1. However, the height of the columnar spacer was set at 1.5 μm.

Whereas, there were prepared two sheets each obtained by forming a transparent electrode made of ITO on one side of a glass substrate, and a film made of Teflon (trade name, the same applies to the following) with a thickness of about 1 μm on the transparent electrode.

Under vacuum, on the alignment film 109, a mixture containing a polymer material precursor and a low molecular weight liquid crystal material was fell into drops. As the low molecular weight liquid crystal material, E7 manufactured by Merck Japan Ltd., which is a nematic liquid crystal composition was used. As the polymer material precursor, an acrylate monomer UCL-001 (manufactured by Dainippon Ink and Chemicals, Incorporated) showing liquid crystallinity, and a non-liquid crystalline multifunctional acrylate monomer (an acrylate monomer containing a plurality of acrylic double bonds in the molecule) KAYARAD HX-220 (manufactured by NIPPON KAYAKU Co., Ltd.) were mixed and used. As a photopolymerization initiator, 2,2-dimethoxy-2-phenylacetophenone was added thereto. The mixing ratios were set in terms of weight percentage as follows: the liquid crystal E7, 95%; UCL-001, 4.7%; HX-220, 0.25%; and 2,2-dimethoxy-2-phenylacetophenone, 0.05%.

Subsequently, the array substrate 10 and the substrate having the Teflon film formed thereon were placed such that the alignment film 109 and the Teflon film faced each other. At this step, the array substrate 10 and the substrate having the Teflon film formed thereon were uniformly controlled at a distance of about 1.5 μm from each other by columnar spacers formed on the array substrate 10.

In this state, all the scanning lines 101 were applied with a direct current voltage of 25 V through the scanning signal input terminals and the image signal input terminals, so that the pixel switches 104 were rendered in an ON state. In addition, all the signal lines 105a were applied with 0 volt. Simultaneously, the transparent electrode formed on the substrate having the Teflon film formed thereon was applied with an alternating current voltage of ±5 V. As a result, the low molecular weight liquid crystal material interposed between the pixel electrodes and the transparent electrode exhibited a hybrid alignment because the liquid crystal molecules were aligned perpendicular to the substrate plane on the Teflon film. In this state, from the opposite side of the array substrate 10 from the side having the alignment film 109 formed thereon, an ultraviolet ray with a main wavelength of 365 nm and an intensity of 3.3 mW/cm² was applied thereto for 3 minutes. As a result, the polymer material precursors were polymerized, so that a liquid crystal layer containing the polymer material and the low molecular weight liquid crystal material was formed.

Thereafter, the array substrate 10 and the substrate having the Teflon film formed thereon were peeled off by gradually exerting a force from the corner portions of the respective substrates. The liquid crystal layer was not left on the Teflon film side, and deposited on the array substrate side. This resulted in the formation of the first liquid crystal layer 30a made of a polymer material and low molecular weight liquid crystal layer on the alignment film 109.

The second liquid crystal layer 30b was also formed in the same manner. Namely, under vacuum, on the alignment film 209, a mixture containing a polymer material precursor and a low molecular weight liquid crystal material was fell into drops. As the low molecular weight liquid crystal material, E7 manufactured by Merck Japan Ltd., which is a nematic liquid crystal composition, was used. As the polymer material precursor, an acrylate monomer UCL-001 (manufactured by Dainippon Ink and Chemicals, Incorporated) showing liquid crystallinity, and a non-liquid crystalline multifunctional acrylate monomer (an acrylate monomer containing a plurality of acrylic double bonds in the molecule) KAYARAD HX-220 (manufactured by NIPPON KAYAKU Co., Ltd.) were mixed and used. As a photopolymerization initiator, 2,2-dimethoxy-2-phenylacetophenone was added thereto. The mixing ratios were set in terms of weight percentage as follows: the liquid crystal E7, 95%; UCL-001, 4.7%; HX-220, 0.25%; and 2,2-dimethoxy-2-phenylacetophenone, 0.05%.

Subsequently, the opposing substrate 20 and the substrate having the Teflon film formed thereon were placed such that the alignment film 209 and the Teflon film faced each other. At this step, the opposing substrate 20 and the substrate having the Teflon film formed thereon were uniformly controlled at a distance of about 1.5 μm from each other by dispersing columnar spacer particles having a diameter of 1.5 μm on the Teflon film.

In this state, the opposing electrode 208 was applied with 0 V. Simultaneously, the transparent electrode formed on the substrate having the Teflon film formed thereon was applied with an alternating current voltage of ±5 V. As a result, the low molecular weight liquid crystal material interposed between the opposing electrode and the transparent electrode exhibited a hybrid alignment. In this state, from the opposite side of the Teflon film-formed side of the substrate having the Teflon film formed thereon, an ultraviolet ray having a main wavelength of 365 nm and an intensity of 3.3 mW/cm² was applied for 3 minutes. As a result, the polymer material precursors were polymerized, so that a liquid crystal layer containing the polymer material and the low molecular weight liquid crystal material was formed.

Thereafter, the opposing substrate 20 and the substrate having the Teflon film formed thereon were peeled off by gradually exerting a force from the corner portions of the respective substrates. The liquid crystal layer was not left on the Teflon film side, and deposited on the opposing substrate side. This resulted in the formation of the second liquid crystal layer 30b made of a polymer material and low molecular weight liquid crystal layer on the alignment film 209.

The subsequent steps were carried out in the same manner as that described in Example 1, thereby to manufacture a liquid crystal display apparatus.

With the liquid crystal display apparatus, even when the liquid crystal panel was strongly pressed with fingers, uneven display did not occur. Incidentally, the absolute value of the voltage to be applied between the pixel electrodes 108 and the opposing electrode 208 was set at 5 V for the ON state, and it was set at 0 V for the OFF state. The front contrast ratio was 400:1, and the response time was 5 ms. The viewing angles (satisfying the conditions such that the contrast ratio is 10:1 or more, and such that gradation inversion is not caused) were 70° C. or more both in the vertical direction and in the horizontal direction.

### Comparative Example 1

In this example, a liquid crystal cell was manufactured in the same manner as that described in Example 1, except that the liquid crystal layer was formed of a single layer containing a polymer material and a low molecular weight liquid crystal material. Namely, the steps up to the point when the alignment films 109 and 209 were formed on the array substrate 10 and the opposing substrate 20, respectively, and a rubbing treatment was carried out, and then, the alignment films 109 and 209 were washed were carried out in the same manner as in Example 1. However, the height of the columnar spacer was set at 5 μm.

In the periphery part of the opposing substrate 20 having the alignment film 209 formed therein, an epoxy type sealing agent was coated in the form of a frame. Under vacuum, on the alignment film 109, a mixture containing a polymer material precursor and a low molecular weight liquid crystal material was fell into drops. Incidentally, the composition of the mixture was set to be the same as that in Example 1.

Subsequently, the array substrate 10 and the opposing substrate 20 were bonded together such that the alignment films 109 and 209 faced each other, and such that their respective rubbing directions were equal to each other. The sealing agent was cured under load. At this step, the array substrate 10 and the opposing substrate 20 were uniformly controlled at a distance of about 5 μm from each other by the columnar spacers formed on the array substrate 10.

In this state, through the scanning signal input terminals and the image signal input terminals, all the scanning lines 101 were applied with a direct current voltage of 25 V. Thus, all the pixel switches 104 were rendered in an ON state. In addition, all the signal lines 105a were applied with 0 V. Simultaneously, the opposing electrode 208 was applied with an alternating current voltage of ±5 V. As a result, the low molecular weight liquid crystal material interposed between the pixel electrodes and the opposing electrode exhibited a bend alignment. In this state, from the opposite side of the array substrate 10 from the side having the alignment film 109 formed thereon, an ultraviolet ray having a main wavelength of 365 nm and an intensity of 3.3 mW/cm² was applied thereto for 3 minutes. As a result, the polymer material precursors were polymerized, and a liquid crystal layer containing the polymer material and the low molecular weight liquid crystal material was formed.

Then, on the outside of the array substrate 10, the optical compensation film 40 and the polarizing plate 50 were bonded. In addition, on the outside of the opposing substrate 20, the optical compensation film 40 and the polarizing plate 50 were bonded. Herein, there was adopted a design such that the retardation of a lamination of the liquid crystal layer 30 between the pixel electrodes 108 and the opposing electrode 208 with a voltage of 5 V applied between the pixel electrodes 108 and the opposing electrode 208, and a total of two optical compensation films 40 bonded on the array substrate and the opposing substrate becomes zero within the substrate plane. Whereas, the polarizing plates 50 were placed such that their transmission axes were generally orthogonal to each other, and such that their respective transmission axes formed an angle of about 45° with respect to the direction X and the direction Y.

Further, to the array substrate 10, the scanning line driver 2, the signal line driver 3, and the like were connected. Thus, the liquid crystal display panel 1 and a backlight were combined. In the foregoing manner, the liquid crystal display apparatus was completed.

When the liquid crystal display apparatus was pressed with fingers from the side of the polarizing plate formed on the opposing substrate, the pressed portion was changed from a bend alignment to a splay alignment, which was visually identified as uneven display. Whereas, the response time of the portion which had not been pressed was measured, and as a result, it was found to be 100 ms.

What is claimed is:

1. A liquid crystal display apparatus comprising:
an array substrate including:
a plurality of scanning lines;
a plurality of signal lines crossing with the plurality of scanning lines;
pixel switches arrayed correspondingly to intersections of the plurality of scanning lines and signal lines, and controlled in the switching operation by scanning signals supplied from the scanning lines;
pixel electrodes connected to the signal lines via the pixel switches; and
a first alignment film covering the pixel electrodes; and
an opposing substrate including:
an opposing electrode facing the pixel electrodes; and
a second alignment film covering the pixel electrode side of the opposing electrode, and placed at a position facing the first alignment film; and
a liquid crystal layer sealed between the first alignment film and the second alignment film, exhibiting a bend alignment with no voltage applied thereto, and containing a polymer material and a low molecular weight liquid crystal material lower in molecular weight than the polymer material,
wherein
the liquid crystal layer includes:
a first liquid crystal layer provided on the first alignment film of the array substrate;
a second liquid crystal layer provided on the second alignment film of the opposing substrate; and
a third liquid crystal layer provided between the first liquid crystal layer and the second liquid crystal layer,
each of the first and second liquid crystal layers includes the polymer material and the low molecular weight liquid crystal material, and
the third liquid crystal layer includes the low molecular weight liquid crystal material.

2. The apparatus as claimed in claim 1, wherein the polymer material has an average molecular weight of 5000 or more.

3. The apparatus as claimed in claim 1, wherein the polymer material is a side chain type polymer liquid crystal material in which a mesogen group is directly or indirectly bonded to the polymer skeleton as a side chain.

4. The apparatus as claimed in claim 1, wherein the low molecular weight liquid crystal material has a molecular weight of 1000 or less.

5. The apparatus as claimed in claim 1, wherein the low molecular weight liquid crystal material is a nematic liquid crystal material with a positive dielectric constant anisotropy.

6. The apparatus as claimed in claim 1, wherein the content of the polymer material in each of the first and in second liquid crystal layers falls within a range of from 2.5% to 10%.

7. The apparatus as claimed in claim 1, wherein the polymer material contains a side chain type polymer liquid crystal material.

8. A liquid crystal display apparatus comprising:
an array substrate including a first alignment film;
an opposing substrate including a second alignment film placed at a position facing the first alignment film; and
a liquid crystal layer sealed between the first alignment film and the second alignment film, exhibiting a bend alignment with no voltage applied thereto, and containing a polymer material and a low molecular weight liquid crystal material lower in molecular weight than the polymer material,
wherein
the liquid crystal layer includes:
a first liquid crystal layer provided on the first alignment film of the array substrate;
a second liquid crystal layer provided on the second alignment film of the opposing substrate; and
a third liquid crystal layer provided between the first liquid crystal layer and the second liquid crystal layer,
each of the first and second liquid crystal layers includes the polymer material and the low molecular weight liquid crystal material, and
the third liquid crystal layer includes the low molecular weight liquid crystal material.

9. The apparatus as claimed in claim 8, wherein the polymer material has an average molecular weight of 5000 or more.

10. The apparatus as claimed in claim 8, wherein the polymer material is a side chain type polymer liquid crystal material in which a mesogen group is directly or indirectly bonded to the polymer skeleton as a side chain.

11. The apparatus as claimed in claim 8, wherein the low molecular weight liquid crystal material has a molecular weight of 1000 or less.

12. The apparatus as claimed in claim 8, wherein the low molecular weight liquid crystal material is a nematic liquid crystal material with a positive dielectric constant anisotropy.

13. The apparatus as claimed in claim 8, wherein the content of the polymer material in each of the first and in second liquid crystal layers falls within a range of from 2.5% to 10%.

14. The apparatus as claimed in claim 8, wherein the polymer material contains a side chain type polymer liquid crystal material.

15. The apparatus as claimed in claim 8, wherein the third liquid crystal layer does not include the polymer material.

16. A liquid crystal display apparatus comprising:
an array substrate including:
a plurality of scanning lines;
a plurality of signal lines crossing with the plurality of scanning lines;
pixel switches arrayed correspondingly to intersections of the plurality of scanning lines and signal lines, and controlled in the switching operation by scanning signals supplied from the scanning lines;
pixel electrodes connected to the signal lines via the pixel switches; and
a first alignment film covering the pixel electrodes; and
an opposing substrate including:
an opposing electrode facing the pixel electrodes; and
a second alignment film covering the pixel electrode side of the opposing electrode, and placed at a position facing the first alignment film; and
a liquid crystal layer sealed between the first alignment film and the second alignment film, exhibiting a bend alignment with no voltage applied thereto, and containing a polymer material and a low molecular weight liquid crystal material lower in molecular weight than the polymer material,
wherein
the liquid crystal layer includes:
a first liquid crystal layer provided on the first alignment film of the array substrate;
a second liquid crystal layer provided on the second alignment film of the opposing substrate; and
a third liquid crystal layer provided between the first liquid crystal layer and the second liquid crystal layer,
each of the first and second liquid crystal layers includes the polymer material and the low molecular weight liquid crystal material, and
the third liquid crystal layer consists of the low molecular weight liquid crystal material selected from the polymer material and the low molecular weight liquid crystal material.
